(19) United States
(12) Patent Application Publication
(10) Pub. No.: US 2009/0166220 A1
(43) Pub. Date: Jul. 2, 2009

(54) MICROCHIP AND ANALYSIS METHOD USING THE SAME

(75) Inventor: Machiko FUJITA, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Minato-ku (JP)

(21) Appl. No.: 12/343,705

(22) Filed: Dec. 24, 2008

(30) Foreign Application Priority Data
Dec. 27, 2007 (JP) 2007-336761

(51) Int. Cl. G01N 27/26; B01J 19/00; B32B 43/00; C23F 1/00; B32B 37/00

(52) U.S. Cl. 205/775; 422/68.1; 156/344; 216/33; 73/863.12

(57) ABSTRACT

Provided is a microchip including a substrate, a channel on the substrate, a lid sealing the channel, and an upper lid bonded to the lid. The lid is formed of an elastic material. The lid is detachable from the substrate. The upper lid is formed of a material harder than the elastic material. The area of the upper lid surface that is bonded to the lid is smaller than the area of the upper surface of the lid.

This application is based upon and claims the benefit of priority from Japanese Patent Application No. 2007-336761, filed on Dec. 27, 2007, the disclosure of which is incorporated herein in its entirety by reference.

### BACKGROUND OF THE INVENTION

1. Field of the Invention

The present invention relates to a microchip, a method for using the microchip, and process for making the microchip.

2. Description of the Related Art

Analytical methods, such as an electrophoresis or a chromatography are used to analyze or identify biological or chemical substances. In the above-mentioned methods, a sample containing the substances are separated or identified in a capillary or on a well-plate.

When the amount of the sample is small, a microchip with a plurality of finely-processed channels would be a useful tool to separate or identify the sample with high accuracy. It is also useful to use the microchip to perform a plurality of analyses. It is called a “multidimensional analysis” to perform such a plurality of analyses.

The microchip contains a substrate including a channel and a lid provided for the channel. The lid is arranged on the substrate to cover the channel. The lid may be combined, bonded or fixed to the channels in a predetermined arrangement. The channel may be formed on the substrate by grooving a plane upper surface of the substrate with a desired shape. Hong et al., Electrophoresis. 2001, 22. 328-33, discloses a method using such a channel to perform electrophoresis of a sample.

Fujita et al., J Chromatogr A. 2006, 1111 (2). 200-5, and WO 2007/069586 disclose an apparatus for a multidimensional analysis. In Fujita et al., and WO 2007/069586, a sample is introduced into a channel of a microchip, and the sample is separated in the channel by capillary electrophoresis. Then a spot position and molecular weight information of separated substances are obtained using matrix-assisted laser desorption/ionization mass spectrometry (MALDI-MS).

Further, WO 2007/069586 proposes a microchip in which a channel is sealed by a removable lid. This microchip includes a substrate including a channel and a reservoir formed therein, and a lid including a through hole formed at a position corresponding to the reservoir. The reservoir is bonded to the substrate in a removable manner. The substrate is made of a synthetic quartz. The lid is made of a silicone resin which is an elastic material. The lid may be detached from the substrate while being bent to be easily removed by lifting up the lid from an end thereof, since a force for lifting up the lid is concentrated on a region in which the lid is bent.

Further, WO 2007/069586 discloses a microchip which realizes a sealed state of the channel with more reliability. The microchip includes a upper lid provided on a lid. The upper lid is made of a synthetic quartz and includes a through hole formed at a position corresponding to the through hole. The upper lid is pressured toward a bottom surface of the substrate by using a fixture. Even in the case of using the fixture in this manner, the upper lid and the lid can be detached and removed from the substrate by removing the fixture.

The channel which holds frozen separated samples can be exposed by separating substances in the sealed channel, performing freeze-fixation to the samples, and then removing the lid, using the above mentioned microchips. Additionally, a separated state of the samples in the channel can be maintained by performing freeze-drying. Further, freeze-dried samples can be crystallized with a matrix in the channel, and the crystallized samples can be analyzed by scanning using a laser beam to detect the substance.

However, the microchips disclosed in WO 2007/069586 have two problems.

The first problem is that it is difficult to detach the lid from the substrate of the microchip, when the substrate is made of a synthetic quartz, the lid is made of a silicone resin, and the upper lid is made of a synthetic quartz. The upper lid is bonded to a top surface of the lid so that the upper lid prevents the lid from bending. In the case of using this microchip, it is required to lift up not only the lid but also the upper lid to detach the lid from the substrate. A force required to detach the lid becomes larger compared with the case where the bending of the lid is possible because the force for lifting up the lid is widely distributed over the entire lid through the upper lid. Since the force is distributed over a wide range of the lid, a large lifting force is required for exceeding an adhesive force between the substrate and the lid to detach the lid. When the lid is lifted up with a large force abruptly, a part of the lid is extremely extended. Then the upper lid or the substrate breaks due to an elastic force of the extremely extended part of the lid. Accordingly, to detach the lid, it is required to control the force for lifting up the edge of the lid in order not to break the upper lid or the substrate so that an operation may be a cumbersome and difficult.

The second problem is called “misalignment” of the lid with the substrate or “curling-up” of the lid, which is caused when the microchip includes only the substrate made of synthetic quartz and the lid made of a silicone resin. For example, when the sample or an electrode solution is introduced or an electrode is inserted into the through hole of the lid, a tip of a pipet or the electrode is hooked on the through hole of the lid to lift up the lid, which causes a solution leakage and deteriorates the separation performance.

### SUMMARY OF THE INVENTION

An exemplary object of the present invention is to provide a microchip aimed to solve the first problem mentioned above.

An exemplary object of the present invention relates to a microchip including a substrate, a channel on the substrate, a lid sealing the channel, and an upper lid bonded to the lid. The lid is formed of an elastic material. The lid is detachable from the substrate. The upper lid is formed of a material harder than the elastic material. The area of the upper lid surface that is bonded to the lid is smaller than the area of the upper surface of the lid.

### BRIEF DESCRIPTION OF THE DRAWINGS

In the accompanying drawings:

FIGS. 1A to 1C show components of a microchip according to a first embodiment of the present invention, in which FIG. 1A is a top view of an upper lid, FIG. 1B is a top view of a lid, and FIG. 1C is a top view of a substrate;

FIG. 2 is a sectional view of the microchip according to the first embodiment, taken along a dashed line A-A of FIG. 1A to 1C;

FIGS. 3A to 3C are step-by-step views schematically showing a detaching operation of the lid of the microchip according to the first embodiment;

FIGS. 4A to 4C show components of a microchip according to a second embodiment of the present invention, in which FIG. 4A is a top view of an upper lid, FIG. 4B is a top view of a lid, and FIG. 4C is a top view of a substrate;

FIGS. 5A and 5B are step-by-step views schematically showing a detaching operation of the lid of the microchip according to the second embodiment;

FIG. 6 is a view schematically showing a problem to be solved by the present invention;

FIG. 7 is a view schematically showing another problem to be solved by the present invention;

FIG. 8 is a drawing explaining a size or an arrangement of the upper lid; and

FIG. 9 is a drawing explaining an arrangement of the through hole arranged in the upper lid.

### EXEMPLARY EMBODIMENT

Hereinafter, embodiments of the present invention are described with reference to the drawings. Note that components common to the respective drawings are denoted by the same symbols, and their descriptions are omitted.

### First Embodiment

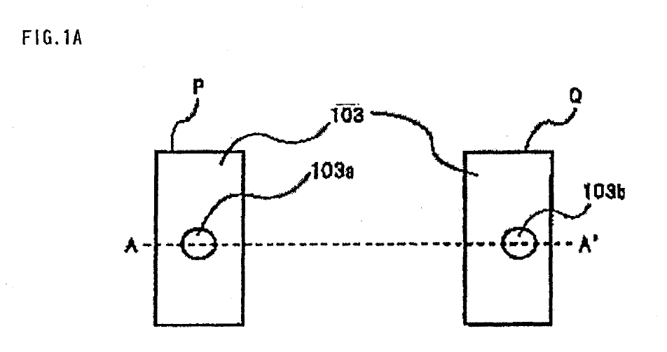

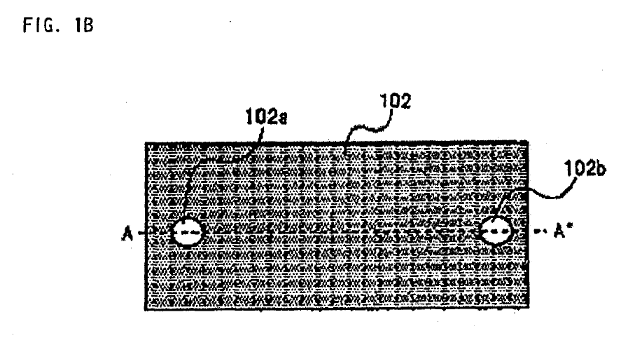

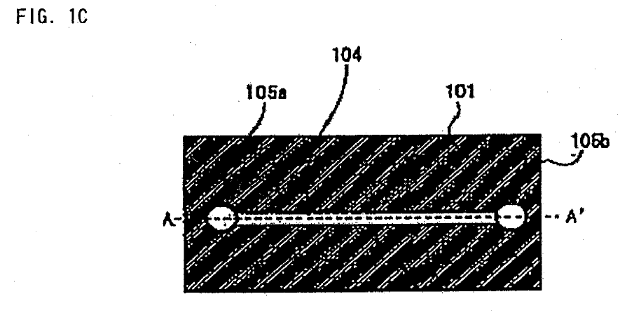

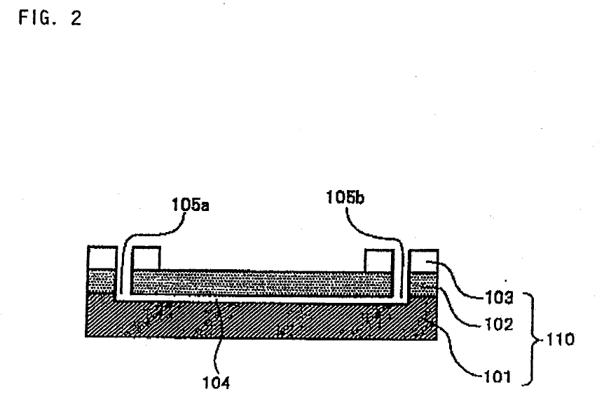

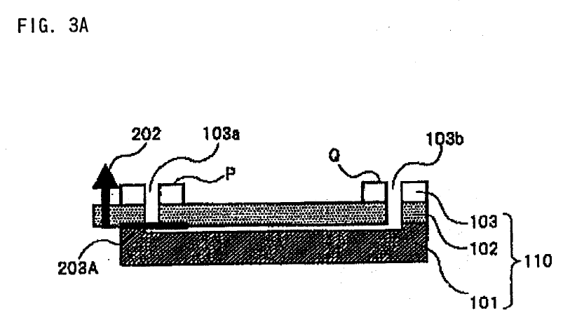

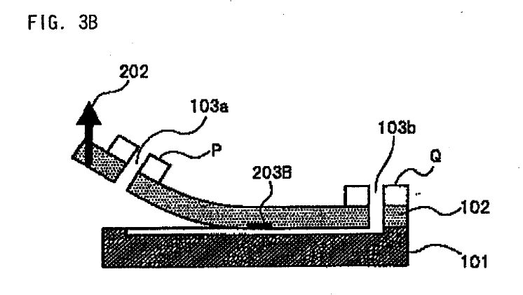

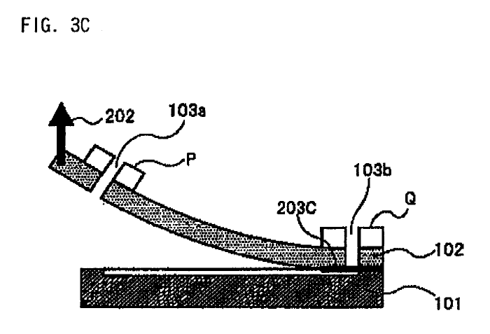

FIGS. 1A to 1C show components of a microchip according to this embodiment, particularly in which FIG. 1A is a top view of an upper lid, FIG. 1B is a top view of a lid, and FIG. 1C is a top view of a substrate. FIG. 2 is a sectional view of the microchip according to this embodiment, taken along a dashed line A-A of FIG. 1. FIGS. 3A to 3C are views schematically showing a detaching operation of the lid of the microchip according to this embodiment.

In a channel structure illustrated as an example in FIGS. 1A to 1C and FIG. 2, a substrate 101 includes, on its top surface, a channel 104 used in separation of a sample containing substances to be analyzed. A first reservoir 105a and a second reservoir 105b for holding solution are formed at both ends of the channel 104. The channel 104 is sealed by an elastic lid 102. The lid 102 includes a first through hole 102a and a third through hole 102b at positions each corresponding to positions of the reservoirs 105a and 105b. Further, an upper lid 103 which is harder compared with the lid 102 is bonded to a top surface of the lid 102. The upper lid 103 includes a second through hole 103a and a fourth though hole 103b at positions each corresponding to the positions of the reservoirs 105a and 105b.

In the upper lid 103, a part (a first portion P) including the second through hole 105a and an other part (second portion Q) including the fourth through hole 105b are not connected to each other. The first portion P is bonded to the lid. The second portion Q is bonded to the lid. The first portion and the second portion are independent from each other. In other words, the upper lid 103 is divided into the first portion P and the second portion Q.

In this embodiment, an isoelectric focusing is performed to analyze a sample using the microchip. The analysis method for a sample according to the present invention is not limited thereto.

A sample containing carrier ampholyte for pH gradient formation and the substance to be analyzed is introduced into the channel 104 through the second and the first through holes 103a and 102a, and the fourth and the third through holes 103b and 102b. After an elapse of a certain period of time, an acid solution (anolyte) for pH gradient formation, which is an electrode solution, is introduced through the second and the first through holes 103a and 102a. Additionally, a base solution (catholyte) is introduced through the fourth and the third through holes 103b and 102b. Then, edges of electrodes for electrical field application are inserted into the reservoirs 105a and 105b through the second and the first through holes 103a and 102a, and the fourth and the third through holes 103b and 102b. Next, an electrical field is applied between those edges of the electrodes to separate the substances in the channel 104.

In the microchip according to this embodiment, the upper lid 103 prevents the lid 102 from becoming misaligned with the substrate or curling up, while introducing the solutions and inserting the electrodes as described above, since the upper lid is arranged on a perimeter of the first and the third through holes 102a and 102b included in the lid. Furthermore, an operation may be performed without causing a solution leakage.

Then, the electric field application is stopped when the substances to be analyzed is separated in the channel 104 at each isoelectric point.

Then, the substrate 101 is cooled to freeze the sample and the electrode solution.

Then, the lid 102 is detached from the substrate 101. The sample and the electrode solution are kept in the frozen state.

The detaching operation is performed as illustrated in FIGS. 3A to 3C. Firstly, a force 202 is applied to an end of the lid 102 to detach the lid 102. The force 202 is exerted to lift up the first portion P of the upper lid 103 including the second through hole 103a and a part of the lid 102 located therebelow (FIG. 3A).

In the case discussed above, the force 202 is exerted on a region 203A, which is a part of the lid 102. The force 202 then transmits to the upper lid 103 including the second through hole 103a.

Then, a part of the lid 102, which is not in contact with the upper lid 103, is detached while being bent (FIG. 3B). On this occasion, the force 202 is exerted on a region 203B, which is a part of the lid 102. The region 203B is the region just before being detached.

Further, the force 202 is exerted to lift up the second portion Q of the upper lid 103 including the fourth through hole 103b and a part of the lid 102 located therebelow (FIG. 3C). On this occasion, the force 202 is exerted on a region 203C, which is a part of the lid 102. The force 202 then transmits to the upper lid 103 including the fourth through hole 103b.

The lid 102 is detached and removed from the substrate 101 after performing the above-mentioned operations.

As described above, the force 202 exerted in the detaching operation acts sequentially on the regions 203A, 203B, and 203C with time intervals, and thus the force required for the detaching operation is small. It is because the area of the upper lid surface that is bonded to the lid is smaller than the area of the upper surface of the lid. Since a large force is not required for lifting the lid up, the upper lid 103 and the substrate 101 may not be broken. Accordingly, the lid 102 can be detached from the substrate 101 easily and conveniently. As a result, the separated state of the frozen sample can be held in the channel 104 even after detaching the lid 102.

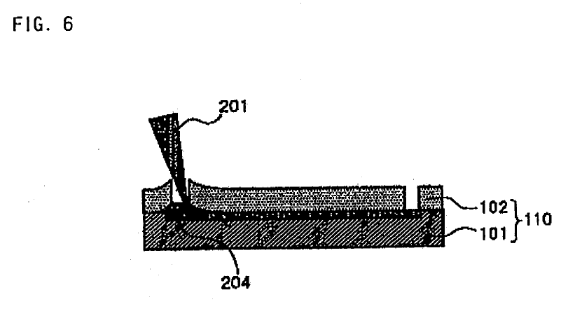

On the other hand, when a microchip without the upper lid is used as shown in FIG. 6, the lid 102 may become misaligned with the substrate 101 or may curl up since a component 201 may contacts with the lid 201, when the component 201 is inserted into the first and the third through hole 102a, 102b to introduce the solution and the electrodes to reservoirs. This may causes a solution leakage and may deteriorate the separation performance of a sample 204.

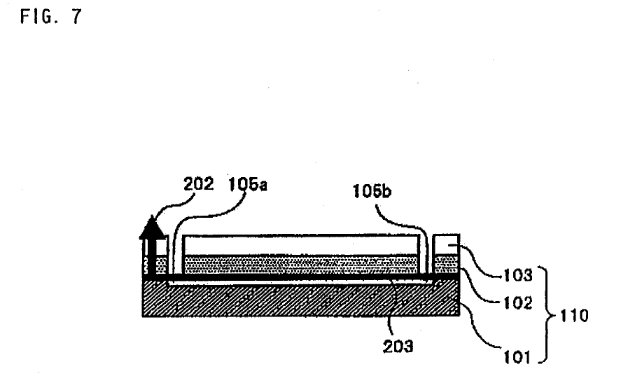

FIG. 7 is a view showing a state of an analysis using the microchip 110 in which the upper lid 103 covers an entire surface of the lid 102. When this microchip is used, the force 202 for detaching the lid is exerted on an entire region 203 of the lid 102. Therefore, the force required to detach the lid becomes larger. Accordingly, the upper lid 103 or the substrate 101 may break by a force abruptly applied thereto.

In contrast, as described above, the microchip according to the present invention can solve the problems inherent in the structures shown in FIGS. 6 and 7.

A material of the substrate 101 according to this embodiment includes, for instance, quartz, glass, and silicon. These materials are suitable for minute processing. Further, plastic materials having a high insulating property, such as polycarbonate, ABS, HDPE and polymethyl methacrylate (PMMA) may be also used.

The channel 104 may be formed by grooving the surface of the substrate 101.

In order to apply an electric field to the channel 104 formed on the top surface of the substrate 101, the substrate 101 itself is required to be insulated from a migration solution contained in the channel 104. Therefore, a material having high insulating property, such as quartz or glass is preferably used for the substrate. In addition, in the case of using a material having low insulating property, such as silicon, a coating film layer having an insulating property is provided on an inner surface of the channel 104 to achieve electrical insulation with respect to the migration solution contained in the channel 104. Alternatively, the channel may be formed on the silicon substrate with a silicon oxide layer formed thereon.

A material of the lid 102 according to this embodiment includes an elastic material such as a polymeric resin material. The polymeric resin material includes polydimethylsiloxane (PDMS), polyolefin such as polytetrafluoroethylene (PTFE), polypropylene (PP), polyethylene (PE), and polyvinyl chloride, and polyester. It is preferable to use a material with insulating property, which can be subjected to processing of, for example, manufacturing a through hole. The lid 102 is manufactured using molding, extrusion, hot embossing, or the like.

A material of the upper lid 103 according to this embodiment includes quartz, glass, silicon, or a plastic material such as polycarbonate, PMMA, and Teflon. It is preferable to use a material having high insulating property, which is harder compared with the lid 102 and can be subjected to the processing of, for example, manufacturing the through hole. The upper lid 103 can be thicker when the material with an elasticity, such as Teflon, is used to prevent from bending.

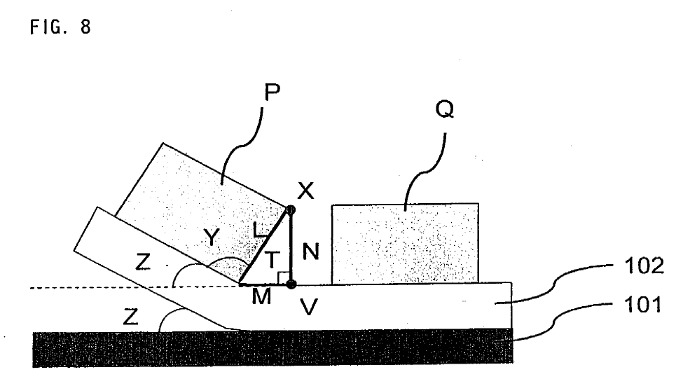

FIG. 8 illustrates a size or arrangement of the upper lid. When the lid is bent, is it able to consider a triangle T contains a side L, a side M, and a side N. The side N is perpendicular to the side M. The side M and the side N can be described as follows.

M=L·cos(180°−Y−Z)

N=M·tan(180°−Y−Z)

A point X of the triangle T is a point included in the first portion P of the upper lid. The point X is the point in the first portion P nearest to the second portion Q of the upper lid and furthest from the upper surface of the lid, in the upper lid P. A point V is included in the upper surface of the lid. The point V is the nearest point in the lid to the point X. Here, the lid is lifted up to make an angle Z, and the first portion P and the second portion Q are detached from the substrate in series.

It is preferable to have the distance from the first portion P to the point V, which is described as the side M in FIG. 8, smaller than the shortest distance between the first portion P and the second portion Q.

If the shortest distance from the first portion P to the point V is bigger than or equal to the shortest distance between the first portion P and the second portion Q, it is preferable to have the height of the second portion Q at the point V smaller than the length of the side N, which is the shortest distance between the point X and the point V. The height of the upper lid Q mentioned above may be the thickness of the upper lid Q.

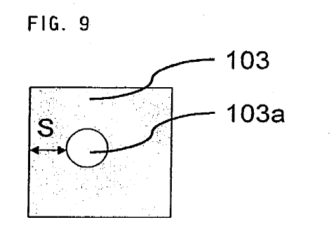

FIG. 9 illustrates a preferable arrangement of the through hole in the upper lid. It is preferable to have a predetermined distance S, the distance from the through hole 103a to a peripheral of the upper lid 103, which enables the lid from becoming misaligned or curling up. The distance S may be equal to or greater than 1 mm.

When the above-mentioned analysis method is performed using the microchip having the above-mentioned structure, the lid 102 can be removed from the substrate 101 easily and conveniently. Accordingly, automation of the detaching operation for the lid can be easily realized.

### Second Embodiment

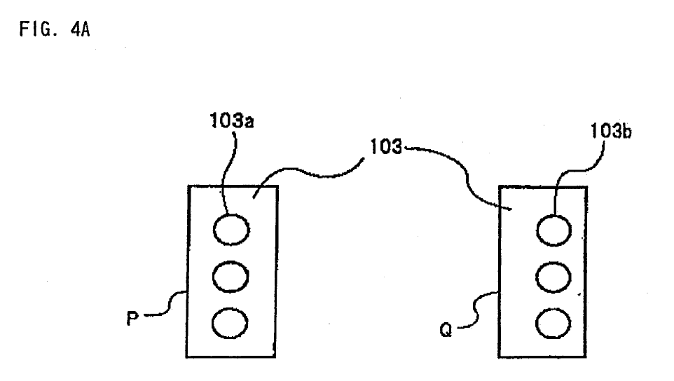

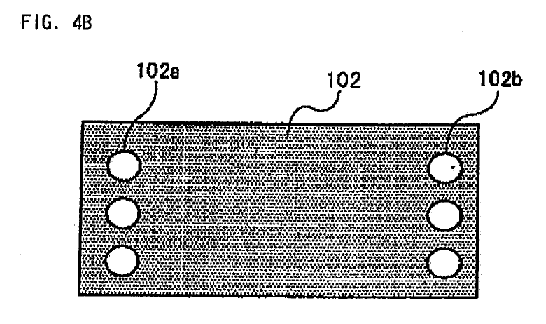

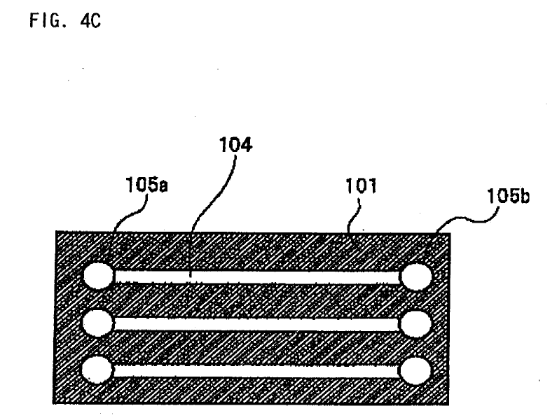

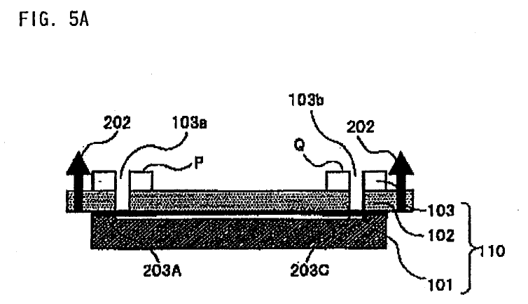

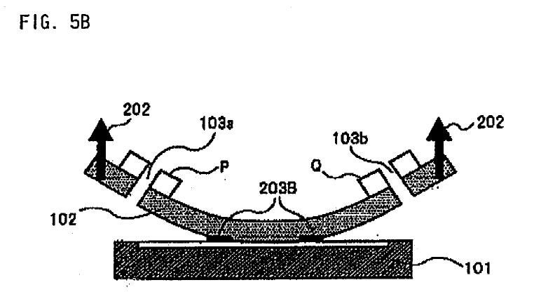

FIGS. 4A to 4C show components of a microchip according to this embodiment, particularly in which FIG. 4A is a top view of an upper lid, FIG. 4B is a top view of a lid, and FIG. 4C is a top view of a substrate. FIGS. 5A and 5B are views schematically showing a detaching operation of the lid of the microchip according to this embodiment.

In FIG. 1C, the channel 104 has only one lane. However, as illustrated in FIG. 4C, the microchip can be a multi-lane microchip including a plurality of channels 104 on the top surface of the substrate 101. A plurality of samples can be analyzed by using only one chip with such a structure, which can reduce the cost.

The upper lid 103 may be shared by the plurality of channels 104. The first portion P and the second portion Q of the upper lid 103 may cover across the plurality of the channels. Two parts of the upper lid 103, the first portion P and the second portion Q, are formed in a shape to cover the plurality of channels 104, and include the through holes 103a and 103b at positions corresponding to the reservoirs 105a and 105b which are coupled to the respective channels 104, respectively.

In this manner, the structure of the upper lid 103 can be simplified, and the microchip can be manufactured with high throughput.

In an analysis method according to this embodiment, as in the first embodiment, substances to be analyzed are separated in the channel 104, and then the substrate 101 is cooled to freeze the sample and the electrode solution. After that, the lid 102 is detached from the substrate 101. The sample and the electrode solution are kept in a frozen state.

The detaching operation is performed as illustrated in FIGS. 5A and 5B. First, as shown in FIG. 5A, the forces 202 for detachment are exerted on both end portions of the lid 102. A force 202 is exerted to lift up the first portion P of the upper lid 103 including the through hole 103a and a part of the lid 102 located therebelow. Another force 202 is exerted to lift up the second portion Q of the upper lid 103 including the through hole 103b and a part of the lid 102 located therebelow.

On this occasion, regions on which the respective forces 202 act are the two regions 203A and 203C of the lid 102, to which the forces 202 are transmitted through the first portion P and the second portion Q.

Then, portions of the lid 102, which are not in contact with the upper lid 103, are detached from the substrate 101 while being bent (FIG. 5B). On this occasion, the forces 202 are exerted on regions 203B of the lid 102 which are the regions immediately before being detached.

Through the above-mentioned operations, the lid 102 is detached and removed from the substrate 101.

As described above, the forces 202 exerted in the detaching operation act for each of the regions 203A, 203B, and 203C, and thus the force required for the detachment is small. Since a large force is not required for lifting up, the upper lid 103 or the substrate 101 may not be broken. Besides, two portions of the upper lid 103, and the parts of the lid 102 located therebelow can be simultaneously detached from the substrate 101, which reduces a period of time required for the detachment.

Therefore, the lid 102 can be easily detached from the substrate 101 in a short period of time. As a result, the separated state of the frozen sample can be held in the channel 104 even after detaching the lid 102.

Materials similar to those of the first embodiment are preferably used for the substrate 101, the lid 102, and the upper lid 103 according to this embodiment.

When the analysis method described above is employed using the above-mentioned microchip 110, the lid 102 can be removed from the substrate 101 easily and conveniently. Moreover, when the two parts of the lid 102, with which the two portions of the upper lid 103 are brought into contact, are lifted up simultaneously, the period of time required for the detaching operation of the lid 102 can be reduced, which leads to a reduction of the period of time required for analysis.

Hereinafter, another embodiment of the present invention is described. This embodiment according to the present invention relates to a microchip including a substrate, a channel on the substrate, a lid sealing the channel, and an upper lid bonded to the lid. The lid is formed of an elastic material. The lid is detachable from the substrate. The upper lid is formed of a material harder than the elastic material. The area of the upper lid surface that is bonded to the lid is smaller than the area of the upper surface of the lid.

The lid can be detached from the substrate with applying a small force, while preventing the upper lid and the substrate from being broken by using the microchip according to the preferred embodiment described above.

The reason for this is as follows. The area of the upper lid surface bonded to the lid is smaller than the upper surface of the lid, which means that the upper lid suppressed the lid from bending only with a small area. As a result, the dispersion of the force for detaching the lid is reduced.

Further, microchip may have reservoirs on the substrate, and through holes in the upper lid and in the lid at positions each corresponding to positions of the reservoirs. An external force is applied to the vicinity of the through hole in the lid when inserting a sample and an electrode solution to the reservoirs using a pipet. Bending of the lid can be suppressed if a hard upper lid is bonded to the top surface of the lid, and therefore, misalignment of the lid with the substrate or curling up of the lid may be prevented

The above has great effects on a microchip including a substrate made of a synthetic quartz, a lid made of a silicone resin, and an upper lid made of a synthetic quartz.

Further, in a microchip having a substrate including a plurality of channels, two parts of an upper lid are each preferably shared by the plurality of channels. Therefore, the structure of the upper lid can be simplified to manufacture the microchip with high throughput.

Further, as another preferred embodiment, there is proposed a method of analyzing a sample using the microchip according to the preferred embodiment described above. As an example of the method, there is employed an analysis method for a sample including a first introducing step, a second introducing step, a separating step, a cooling step and a detaching step. In the first introducing step, the sample containing a substance to be analyzed is introduced into the channel through the through hole included in the upper lid, the through hole included in the lid, and the reservoir. In the second introducing step, the electrode solution is introduced into the other through hole included in the upper lid, the other through hole included in the lid, and the other reservoir. In the separating step, the sample is separated in the channel. In the cooling step, the substrate is cooled, whereby the separated sample held in the channel and the electrode solution of the reservoir are frozen. In the detaching step, an external force is applied to end parts of the lid to detach and remove the lid from the substrate. While performing the detaching step, it is preferable to cool the substrate to maintain it at a predetermined temperature. The separated sample in the frozen state which is held in the channel may be exposed while after these steps.

When the above-mentioned analysis method is performed, by using the microchip according to the embodiment described above, the problems of “misalignment” or “curling up” of the lid can be avoided even in introducing the sample or the electrode solution, or inserting the electrode. Moreover, the lid can be removed from the substrate easily and conveniently after the sample containing the substance to be analyzed is separated and frozen.

Further, in the above-mentioned detaching step, there are a first step detaching a part of the lid which is located below the first portion of the upper lid and a second step detaching an other part of the lid which is located below the second portion of the upper lid. The first step and the second step are preferably performed with a time interval. If the lid is detached for each separated region of the upper lid, an area detached at one time becomes smaller without fail. Accordingly, the force required for lifting up the lid is reduced, with the result that the lid can be removed from the substrate more easily and conveniently.

Note that, preferably, the embodiments described above are appropriately combined for use.

### Example

The inventors of the present invention have demonstrated that, with the use of a microchip described below, a lid can be easily detached from a substrate while preventing the upper lid and the substrate from being broken, and the lid from becoming misaligned or curling up.

The substrate 101 of the microchip according to the embodiment shown in FIGS. 1A to 1C and FIG. 2 is a rectangular substrate which is made of a synthetic quartz. A size of the substrate is 21 mm×42 mm and a thickness is 0.5 mm. The channel 104 is formed by performing photolithography and dry etching on a top surface of the substrate 101. The channel 104 is formed of a linear groove having a width of 1 mm and a length of 32 mm. Four channels 104 are formed on one chip. A columnar structure having a diameter of 10 μm and a pitch of 20 μm is uniformly formed in the channel 104. Reservoirs 105a and 105b are formed at both ends of the respective channels 104. Fluorine is coated on surfaces other than surfaces of the channels 104 of the substrate 101.

The lid 102 is formed of a silicone resin (PDMS). A size of the lid is 19 mm×44 mm and a thickness is 2 mm. The lid includes the through holes 102a and 102b having a diameter of 2 mm at positions corresponding to the reservoirs 105a and 105b. The lid 102 is formed by mixing a silicone resin material with a curing agent, pouring the mixture into a forming die, and heating the mixture at 150° C. for one hour to be cured. Since the PDMS is a material with a small adhesive force, the lid 102 can be easily detached and removed from the substrate 101 if there is no arrangement on the lid 102.

The upper lid 103 is a rectangular substrate which is made of a synthetic quartz. A size of the upper lid 19 mm×6 mm and a thickness is 1 mm. The upper lid 103 includes the through holes 103a and 103b having a diameter of 2 mm at positions corresponding to the reservoirs 105a and 105b, respectively.

With regard to a long side of the microchip according to this example, the lid 102 is larger than the substrate 101 by 2 mm, and the lid 102 is combined with the substrate 101 so that the lid 102 may protrudes from an end of one side of the substrate 101. The protruding portion of the lid 102 becomes a pull portion which is pulled when detaching the lid 102.

With regard to a short side of the microchip, the lid 102 is smaller than the substrate 101 by 1 mm at both ends thereof. Therefore, the lid 102 is combined with the substrate 101 in a state in which the substrate 101 has regions devoid of the lid 102 at both edges thereof. The regions of the substrate 101, which are devoid of the lid 102, become hook portions for fixing the microchip to a stage. This region may prevents the substrate 101 from being lifted up when the lid 102 is lifted up.

The microchip is put on the stage of a Peltier device including a cooling mechanism and a heating mechanism.

A fluorescent IEF marker was used to observe the separated state. A cIEF gel containing 2% cIEF ampholytes for pH gradient formation and 2% fluorescent IEF marker in the channel 104 was analyzed. A voltage is applied to the cIEF gel.

An analysis method is described as follows. First, the analysis sample was introduced into the reservoirs 105a and 105b through the through holes 103a and 102a, and the through holes 103b and 102b. Then the sample was introduced into the channel 104 by using a capillary force. Next, the reservoir 105a was filled with 0.02 M NaOH (pH 12.4) as an electrode solution. The reservoir 105b was filled with 0.1 M H3PO4 (pH 1.9) as the electrode solution. Next, the electrodes were inserted into both the reservoirs 105a and 105b. Next, a voltage of 2.4 kV was applied between the electrodes for four minutes, and the fluorescent IEF marker was subjected to isoelectric focusing. A separated state of the fluorescent IEF marker in the channel 104 was observed using a fluorescence microscope.

The microchip immediately after the observation was cooled by using the Peltier device, thereby freezing the analysis sample and the electrode solution.

Further, the pull portion of the lid 102 was lifted up to detach and remove the lid 102 and the upper lid 103 from the substrate 101. While detaching the lids from the substrate, the analysis sample and the electrode solution were maintained in the frozen state. Moreover, the substrate 101 was fixed to the stage by using the hook portions thereof. Then, the fluorescence of the channel 104 was observed, which revealed that the separated state of the fluorescent IEF marker was not damaged but maintained even after the removal of the lid 102 and the exposure of the analysis sample.

The experiment described above revealed that, with the use of the microchip, the lid 102 can be easily detached from the substrate 101. The lid of the microchip may not become misaligned or curling up through the isoelectric focusing step, the cooling step, and the detaching step.

The microchip includes the substrate 101 including the channel 104 and the reservoirs 105a and 105b, the elastic lid 102 equipped with the through holes 102a and 102b, and the upper lid 103 formed of the material which is harder compared with the lid 102 and including the through holes 103a and 103b, in which the upper lid 103 is divided into the first portion including the through hole 103a and the second portion including the through hole 103b.

The microchip and the analysis method for a sample using the same according to the present invention, which have been illustrated above, can be used in a further analysis. For example, a separated sample being on a microchip can be used in a mass analysis or a bioassay analysis, by detaching the lid manually or automatically.

While a preferred embodiment of the present invention has been described using specific terms, such description is for illustrative purposed only, and it is to be understood that changes and variations may be made without departing from the spirit or scope of the following claims.

What is claimed is:

1. A microchip, comprising:
a substrate;
a channel on the substrate;
a lid sealing the channel; the lid being formed of an elastic material; the lid being detachable from the substrate; and
a upper lid bonded to the lid; the upper lid being formed of a material harder than the elastic material;
wherein:
the area of the upper lid surface that is bonded to the lid is smaller than the area of the upper surface of the lid.

2. A microchip according to claim 1, wherein:
the upper lid includes a first portion bonded to the lid and a second portion bonded to the lid; and
the first portion and the second portion are independent from each other.

3. A microchip according to claim 2, further comprising:
a first reservoir located at an end of the channel;
a first through hole, included in the lid, being at a position corresponding to the first reservoir;
a second through hole, included in the upper lid, being at a position corresponding to the first reservoir;
a second reservoir located at another end of the channel;
a third through hole, included in the lid, being at a position corresponding to the second reservoir; and
a fourth through hole, included in the second portion, being at a position corresponding to the second reservoir.

4. A microchip according to claim 3, wherein:
the first portion includes a point X; the point X being the point in the first portion nearest to the second portion and furthest from the upper surface of the lid;
the upper surface of the lid includes a point V; the point V being the nearest point in the lid to the point X; and
the shortest distance from the first portion to the point V is smaller than the shortest distance between the first portion and the second portion when the lid is bent.

5. A microchip according to claim 3, wherein:
the first portion includes a point X; the point X being the point in the first portion nearest to the second portion and furthest from the upper surface of the lid;
the upper surface of the lid includes a point V; the point V being the nearest point in the lid to the point X; and
the shortest distance from the first portion to the point V is bigger than or equal to the shortest distance between the first portion and the second portion; and
a height of the second portion at the point V is smaller than the shortest distance between the point X and point V when the lid is bent.

6. A microchip according to claim 3, wherein:
the shortest distance from the second through hole to a peripheral of the first portion is a predetermined distance which can prevent the lid from becoming misaligned or curling up.

7. A microchip according to claim 6, wherein:
the predetermined distance is equal to or greater than 1 mm.

8. A microchip according to claim 1, wherein:
the substrate comprises a plurality of channels; and
the upper lid covers across the plurality of the channels.

9. A microchip according to claim 1, wherein:
the substrate includes at least one of synthetic quartz, quartz, glass, polycarbonate, ABS, HDPE and polymethyl methacrylate (PMMA).

10. A microchip according to claim 1, wherein:
the lid includes a silicone resin.

11. A microchip according to claim 1, wherein:
the upper lid includes at least one of synthetic quartz, quartz, glass, silicon, polycarbonate, PMMA, and teflon.

12. A method for detaching a lid of a microchip comprising:
detaching the lid of the microchip comprising:
a substrate;
a channel on the substrate;
a lid sealing the channel; the lid being formed of an elastic material; the lid being detachable from the substrate; and
a upper lid bonded to the lid; the upper lid being formed of a material harder than the elastic material;
wherein:
the area of the upper lid surface that is bonded to the lid is smaller than the area of the upper surface of the lid.

13. A method for detaching a lid of a microchip according to claim 12, wherein:
the microchip further comprises:
the upper lid includes a first portion bonded to the lid and a second portion bonded to the lid; and
the first portion and the second portion are independent from each other.

14. A method for detaching a lid of a microchip according to claim 13, wherein:
the microchip further comprises:
a first reservoir located at an end of the channel;
a first through hole, included in the lid, being at a position corresponding to the first reservoir;
a second through hole, included in the upper lid, being at a position corresponding to the first reservoir;
a second reservoir located at another end of the channel;
a third through hole, included in the lid, being at a position corresponding to the second reservoir; and
a fourth through hole, included in the second portion, being at a position corresponding to the second reservoir.

15. A method for detaching a lid of a microchip according to claim 14, further comprising:
a first step detaching a part of the lid which is located below the first portion, and
a second step detaching an other part of the lid which is located below the second portion;
wherein:
the first step and the second step are performed with a time interval.

16. A method for analyzing a sample according to claim 15, further comprises:
analyzing the sample.

17. A method for analyzing a sample according to claim 16, further comprises:
introducing the sample into the first reservoir;
introducing an electrode solution into the second reservoir;
separating the sample in the channel; and
cooling the substrate to freeze the separated sample held in the channel and the electrode solution in the reservoirs.

18. A method for making a microchip, comprising:
performing photolithography and etching on the surface of the substrate to form a channel;
forming a lid on the substrate; and
forming a upper lid;
wherein:
the lid is formed of an elastic material;
the lid is detachable from the substrate;
the upper lid is bonded to the lid;
the upper lid is formed of a material harder than the elastic material; and
the area of the upper lid surface that is bonded to the lid is smaller than the area of the upper surface of the lid.

19. A method for making a microchip according to claim 18, wherein:
the upper lid includes a first portion bonded to the lid and a second portion bonded to the lid; and
the first portion and the second portion are independent from each other.

20. A method for making a microchip according to claim 19, further comprises:
forming a reservoir on the surface of the substrate;
forming a through hole in the lid;
forming a through hole in the upper lid; wherein:
the through hole formed in the lid and the through hole formed in the upper lid arranged at a position corresponding to the reservoir.
